(19) United States
(12) Patent Application Publication
(10) Pub. No.: US 2012/0199208 A1
(43) Pub. Date: Aug. 9, 2012

(54) METHOD FOR GENERATING MARKED BATCHES OF WATER

(75) Inventors: Marc Moreau, Suresnes (FR); Cyrille Lemoine, Sartrouville (FR)

(73) Assignee: VEOLIA EAU- COMPAGNIE GENERALE DES EAUX, PARIS (FR)

(21) Appl. No.: 13/377,555

(22) PCT Filed: Jun. 9, 2010
(86) PCT No.: PCT/FR2010/051142

§ 371 Date: Apr. 12, 2012

(30) Foreign Application Priority Data
Jun. 11, 2009 (FR) 0953899

(51) Int. Cl. E03B 1/00; C09K 3/00; C01B 5/00

(52) U.S. Cl. 137/1; 137/561 R; 423/580.1; 252/182.32

(57) ABSTRACT

A method of generating a series of successive marked parcels of water in a water distribution network (12) fed by at least one water source (16) supplying water continuously, the method being characterized in that it includes: a step of measuring at least one first physico-chemical parameter of water from the source; a step of comparing the variation of the first parameter and a predetermined threshold; a step of defining parcels of water (L1, L2, L3, L4) during which each parcel of water is constituted by the volume of water supplied by the source between a first time and a second time later than the first time, the second time being determined automatically so as to correspond to a time at which said at least one measured first parameter is subject to a variation greater than the predetermined threshold; a step of acquiring and storing a natural evolution of the measured first parameter between the first and second times; and a step of natural marking of said parcel of water that consists in associating said natural evolution of said first parameter with said parcel of water.

### BACKGROUND OF THE INVENTION

The present invention relates to the field of monitoring the quality of water in distribution networks.

A water distribution network is traditionally fed at the upstream end by one or more water sources, for example a drinking-water production unit or a reservoir containing drinking water. The water is then distributed at the downstream end, generally to a plurality of consumers, such as individual houses, apartment and office blocks, hospitals, schools and other drinking-water consumers.

The quality of the distributed water tends to deteriorate over time and for end-to-end quality control it is important to know the residence time in the network and the path followed in the network. There are several existing approaches for tracking the quality of the water in a distribution network. One of them consists in adding an additive to the water in the network so as to present a concentration peak, as described in US 2008/0109175. A series of sensors then tracks the movement of this concentration peak in the network.

That basic method, which relies on tracking a single parameter, has the disadvantage of always requiring an additive to be added to the water and it does not constitute a permanent and continuous method of tracking drinking water in a distribution network.

The paper by O'Halloran “Sensor-based water parcel tracking” (Water distribution system analysis symposium 2006: proceedings of the 8th annual water distribution systems analysis symposium, Aug. 27-30, 2006, Cincinnati, Ohio, USA, Jan. 1, 2007), suggests using the natural fluctuations of a parameter of the water in order to be able to track in a network a portion of water defined in an entirely arbitrary manner. However, the recognition method described is essentially manual and requires a particularly well-trained operative. The paper also indicates that the correlation algorithm envisaged for automatic water portion identification offers relatively low performance and cannot take account of a variable water flow rate. The method described is therefore difficult to implement automatically in a real drinking-water network.

### OBJECT AND SUMMARY OF THE INVENTION

An object of the present invention is to propose a marking method that remedies the above-mentioned drawbacks.

The invention firstly provides a method of generating a series of successive marked parcels of water in a water distribution network fed by a water source supplying water continuously, the method comprising:

a step of measuring at least one first physico-chemical parameter of water from the source;

a step of comparing the variation of the measured first parameter and a predetermined threshold;

a step of defining parcels of water during which each parcel of water is constituted by the volume of water supplied by the source between a first time and a second time later than the first time, the second time being determined automatically so as to correspond to a time at which said at least one measured first parameter is subject to a variation greater than the predetermined threshold;

a step of acquiring and storing a natural evolution of the measured first parameter between said first and second times; and

a step of natural marking of said parcel of water that consists in associating said natural evolution of said at least one first parameter with said parcel of water.

Thus natural marking of the parcel of water is based on the natural evolution of the first physico-chemical parameter without requiring the addition of an additive in order to create a concentration peak. This natural evolution constitutes a fingerprint of the water, making it possible to identify the corresponding parcel of water flowing between the two times. In the context of the invention, natural marking is therefore carried out without addition of marking products, without addition of chemicals. Thus natural marking is distinguished from artificial marking, which requires adding an additive or tracker to the water.

Each parcel of water generated in accordance with the present invention has time limits constituted by the first and second times associated with said parcel of water. In contrast to the above-mentioned prior art, in the context of the invention the parcel of water is therefore defined automatically and not arbitrarily, and so the generation method is preferably used to generate automatically a series of marked parcels of water defined at successive times for which the variation of the measured first parameter is above the predetermined threshold.

Note that the first time of a parcel of water preferably corresponds to the second time of the previous parcel of water so that the parcels of water are generated continuously, one after the other.

The parcels of water are preferably marked differently, so that it is possible to recognize a parcel of water from its markings. Each natural evolution associated with a marked parcel of water could advantageously be stored in a database.

It is equally clear that the parcels of water do not necessarily have the same volume in the sense that the “physical” ends of each of the parcels of water depend on the time at which a significant variation in the first physico-chemical parameter occurs. It is therefore clear that it is the natural evolution of the first parameter that defines the size of the parcels of water. Thus the time between the first and second times of two successive parcels of water is not necessarily constant.

It should be added that this variation depends on parameters that may evolve during the drinking-water production process. For example, the evolution of the first parameter may result from a modification of the source of the untreated water or the type and quantity of chemicals used to treat the untreated water. The variation of said physico-chemical parameter is therefore a good reflection of an evolution of the production conditions and logically defines the limit of the parcel that will be tracked in the network.

The predetermined threshold could be expressed as a percentage variation of the first parameter, for example.

The first parameter is preferably chosen so that its evolution within the parcel of water is conserved during its movement in the distribution network or is at least not much affected, so that the invention makes it possible to track drinking water. This first parameter is referred to as the marker parameter.

Without departing from the scope of the present invention, a plurality of physico-chemical parameters may be used associated with a plurality of predetermined thresholds. In this variant, the second time corresponds to a time at which the variation in one of the parameters is greater than its predetermined threshold, for example.

Said at least one first parameter is preferably selected from the chlorine concentration, pH, conductivity, turbidity, mineral species concentration, and natural isotopes.

The parameters evolve naturally depending on the source of the untreated water or as a function of the process used to treat the untreated water.

It is therefore clear that the marking of the parcel of water as explained above is natural marking in the sense that it reflects the normal process for producing drinking water.

According to an advantageous aspect of the invention, this natural marking is associated with artificial marking.

To this end, the method of the invention further includes an artificial marking step in which there is injected into water from the source at least one marker additive to modify significantly the value of said at least one first parameter, this injection being effected at least at the first time and/or at the second time.

Thus to define the parcels of water this marker additive is added intentionally, in addition to the additives necessary to render the water drinkable. In other words, if the first parameter varies little, and so the variation of the first parameter is rarely greater than the predetermined threshold, injecting the marker additive makes it possible to force the definition of a parcel of water.

This injection of marker additive also makes it possible to define artificially sub-parcels of water within a parcel of water that is defined naturally. It also makes it possible to show up modifications of production conditions that would not be reflected in a variation of the first parameter (for example use of a new reagent tank without changing the quantities used).

The artificial marking step preferably consists in carrying out a plurality of successive injections of marker additive in accordance with a marking injection rule that may be constituted by one or more concentration peaks, for example.

Moreover, the marker additive is preferably chosen from additives used in the process of producing drinking water (such as a chlorinated disinfectant, a reagent adapted to modify the pH of the water or its mineral content, a substance for inhibiting the precipitation of CaCO₃ and corrosion, nanofiltered water, a mineral species or natural isotopes).

Chlorinated disinfectant means mainly, although not exclusively, chlorine or chlorine dioxide. Said reagent may for its part be selected from sodium hydroxide, sodium carbonate, sodium chloride, or lime. The inhibiting substance may be sodium silicate or phosphoric acid. Finally, the mineral species may be fluorine.

Obviously, these species are chosen to conform to the regulations applicable to drinking water distributed in a network in terms of drinkability and acceptability (color, odor, etc.).

In an advantageous variant of the method of the invention for generating a marked parcel of water, the measurement step further includes measuring a second physico-chemical parameter, wherein the second time corresponds to a time at which the first parameter is subject to a variation greater than a predetermined first threshold and the second parameter is subject to a variation greater than a predetermined second threshold, there is further effected a step of acquiring and storing an evolution of the measured second parameter between the first and second times, and the marking step consists in associating with the parcel of water the evolution of the first and second measured parameters.

Thus each parcel of water is marked by the evolution of the first and second parameters. One benefit is that this improves the distinction between how the different parcels of water are marked, which improves water parcel identification and thus traceability.

More parameters could be used without departing from the scope of the present invention.

In another advantageous variant the method of the invention further includes a modulation step consisting in injecting into water from the source, between the first and second times and in accordance with a modulation injection rule, at least one first modulation additive adapted to modify the value of one of said physico-chemical parameters of the water, referred to as “the information-carrying parameter”, so as to code information in the parcel of water.

Various techniques for coding information by modulation are well-known, but in an entirely different technical field, namely and primarily the field of telecommunications. The modulation injection rule corresponds, for example, but not exclusively, to a binary signal composed of a succession of bits corresponding to the value “0” or “1”. To this end, a “1” bit corresponds to injection of the additive for a predetermined time and a “0” bit corresponds to the absence of injection for another predetermined time.

Other coding techniques may be used without departing from the scope of the invention, such as a signal having a predetermined Fourier transform, for example.

The coded information preferably relates in particular to identifying the water source and/or to the date and time of defining the parcel of water. Other types of information could very well be coded, however.

A benefit of coding information in the parcels of water is that this improves the traceability of parcels of water in the network. In the event of a parcel of water of degraded quality being detected in the network, it is possible by means of the invention to determine the place and the date and time of production of the parcel of water concerned in order to assist operatives detect possible pollution in the network.

To improve the reliability of the coding and the decoding of the information coded in each of the parcels of water, during the modulation step, a second modulation additive is injected into the water from the source between the first and second times and in accordance with an injection rule of the clock type, said second additive being adapted to modify the value of another of said physico-chemical parameters of the water, referred to as “the clock-signal parameter”, to code a clock signal in the parcel of water.

The clock signal is preferably a regular succession of bits having the alternating values “0” and “1”.

Thus at least one item of information and preferably at least one clock signal are coded in the parcel of water. The information is preferably coded in the form a binary signal and the clock signal provides a scale of graduations against which to read this binary signal. To this end, the rising and/or falling edges of the clock signal are used to define the bits of the signal coding the information. As indicated above, an essential benefit resides in the improvement of decoding, i.e. of reading the information coded in the parcel of water. To the extent that the signal coding the information tends to become distorted during propagation of the parcel of water in the network, reading this information downstream may be difficult or sometimes falsified. If the clock signal is distorted in a similar manner to the signal coding the information, it is then easy to reconstitute because the structure of the clock signal is chosen in advance and is preferably the same for a plurality of water parcels.

It is preferable if the first modulation additive is an acid species, the information-carrying parameter is the pH, the second modulation additive is nanofiltered water, and the clock-signal parameter is the conductivity.

The acid species enables the pH of the water to be varied in accordance with a signal coding the information, and injecting nanofiltered water enables the conductivity of the water to be varied in accordance with the clock signal.

The invention further provides a marked parcel of water obtained by the method of the invention.

The invention further provides a device for generating a series of successive marked parcels of water in a distribution network fed by a water source supplying water continuously. According to the invention, this device comprises:

means for measuring at least one first physico-chemical parameter of water from the source;

means for comparing the variation of the measured first parameter and a predetermined threshold;

means for defining parcels of water, each parcel of water being constituted by the volume of water supplied by the source between a first time and a second time later than the first time, the second time being determined automatically so as to correspond to a time at which the first parameter is subject to a variation greater than the predetermined threshold;

means for acquiring and storing a natural evolution of the measured first parameter between said first and second times; and

means for natural marking of said parcel of water by associating said natural evolution with said parcel of water.

If the distribution network is fed by a plurality of sources, each of the sources may be equipped with a device for generating marked parcels of water.

The device of the invention advantageously further includes a database in which are stored for each marked parcel of water both an identifier of said marked parcel of water and the temporal evolution of the first parameter.

In one variant, the measuring means are adapted to measure a plurality of physico-chemical parameters and the database associates with each water parcel identifier the evolution of the various physico-chemical parameters.

In an advantageous embodiment, the device further includes artificial marker means for injecting into water from the source at least one marker additive for significantly modifying the value of the first parameter, this injection being carried out in accordance with a marking injection rule at least at the first time and/or at the second time.

In an advantageous variant, the device further includes modulation means for coding information in the parcel of water, said means being adapted to inject into water from the source, between the first and second times and in accordance with a modulation injection rule, at least one first modulation additive adapted to modify the value of the first parameter.

The invention further provides a water distribution system comprising at least one water source, a water distribution network fed by said source and provided with a plurality of pipes, at least one device for generating parcels of water marked in accordance with the invention, disposed at the outlet of the water source to generate continuously a plurality of marked parcels of water, and tracking means for tracking the marked parcels of water in the network.

This system enables tracking of the parcels of water generated by the device disposed at the outlet from the source, which improves control of the quality of water in the network.

The tracking means advantageously comprise:

a plurality of sensors disposed on the pipes of the network, said sensors being adapted to measure the variation over time of at least the first parameter;

calculation means for identifying the batches of water and determining their position in the network from the measurements provided by the sensors and all of the stored evolutions.

The calculation means preferably use the above-mentioned database.

For decoding the information, the system further includes reader means for reading the information coded in each parcel of water.

These reader means employ mathematical decoding and demodulation algorithms that are well-known, notably in the field of telecommunications.

The sensors are preferably adapted to measure a plurality of physico-chemical parameters. Such “multisensors” are well-known.

Finally, in another variant, the system of the invention further includes a digital model of the hydraulic and kinetic behavior of the distribution network and said model is updated from the data supplied by the tracking means.

The digital model of the hydraulic and kinetic behavior of the network is traditionally used in centers for surveillance of drinking-water distribution networks. According to the invention, tracking the marked parcels of water makes it possible to refine the parameters and reliability of the digital model. This improved model also enables tracking of parcels of water in parts of the network that are not equipped with sensors.

In the light of the above, it is clear that in the context of the present invention and as used in the agriculture-foodstuffs industry the concept of a “parcel” of water constitutes a unit that is “produced, fabricated, or conditioned under practically identical circumstances”.

Thus the invention makes it possible to identify a parcel of water and to track its distribution employing tracking logic of the agriculture-foodstuffs industry type.

In particular, based on measuring the same physico-chemical parameter at two points of a water network, the system of the invention makes it possible to calculate the time taken for the water to travel between these two points. To this end, characteristic structures (for example peaks) are identified on the two curves obtained that serve as points of departure for evaluating a time difference and an attenuation (for parameters such as the chlorine concentration that do not remain the same over time). The two curves obtained are compared and the delay and the spreading caused by variations in the flow rate of the water (for example by the Doppler effect) are determined segment by segment. A curve is then obtained of the time taken to travel between the two measurement points. This method makes it possible to obtain the result rapidly. It is possible to evaluate the travel time of the water over several days in a few minutes.

Moreover, if the same source feeds a point of the network via two paths (for example via different pipes), the system of the invention advantageously estimates the travel time and the attenuation of each of the two paths and the relative proportions of the water in each path. A change in the direction of flow of the water may equally be determined using the present invention.

In another embodiment of the invention, the water distribution system of the invention includes at least first and second water sources, the first water source being associated with a first device for generating marked parcels of water generating a series of first marked parcels of water, while the second water source is associated with a second device for generating marked parcels of water generating a series of second marked parcels of water. In this embodiment the calculation means are also adapted to determine the source of a portion of water resulting from mixing of the first and second parcels of water. To this end, said calculation means determine a delay value and an attenuation value for each of these sources, as well as a mixing rate.

If two water sources feed a distribution network, it is fairly frequent for the parcels of water to mix in the network. There are then obtained portions of water resulting from the mixing of one or more parcels of water from the first and second sources. The system of the invention makes it possible to track and identify these portions of water by determining their provenance and travel time. To this end, the calculation means estimate the delay and the attenuation (of the signal corresponding to the measured parameter) for each source and the mixing rate, an optimization method being used to look for values of this data enabling the observed measurement to be obtained at a node of the network.

### BRIEF DESCRIPTION OF THE DRAWINGS

The invention can be better understood on reading the description given below by way of illustrative but non-limiting example and with reference to the appended drawings, in which:

FIG. 1 shows diagrammatically a water distribution system of the invention including a device for generating marked parcels of water disposed at the outlet from a drinking-water production unit;

FIG. 2 shows diagrammatically the structure of the device from FIG. 1 for generating parcels of water;

FIG. 3 shows the variation in the concentration of chlorine in the water over time;

FIG. 4 shows a curve conforming to one example of a marking injection rule;

FIG. 5 is a graph showing the evolution of two physico-chemical parameters of the water from the FIG. 1 reservoir on the basis of which six marked parcels of water are defined;

FIG. 6 shows the injection curve of a first modulation additive conforming to a modulation injection rule and the injection curve of a second modulation additive conforming to a clock-type injection rule, information being coded in the first modulation parameter;

FIG. 7 shows the variation of first and second modulation parameters both measured at the output of the FIG. 2 generator device;

FIG. 8 is a graph showing the variations of the modulation parameters and the first parameter measured by one of the sensors disposed in the FIG. 1 network; and

FIG. 9 shows diagrammatically the evolution between times t1 and t2 of the first parameter, which is associated with one of the marked parcels of water.

### DETAILED DESCRIPTION OF AN EMBODIMENT OF THE INVENTION

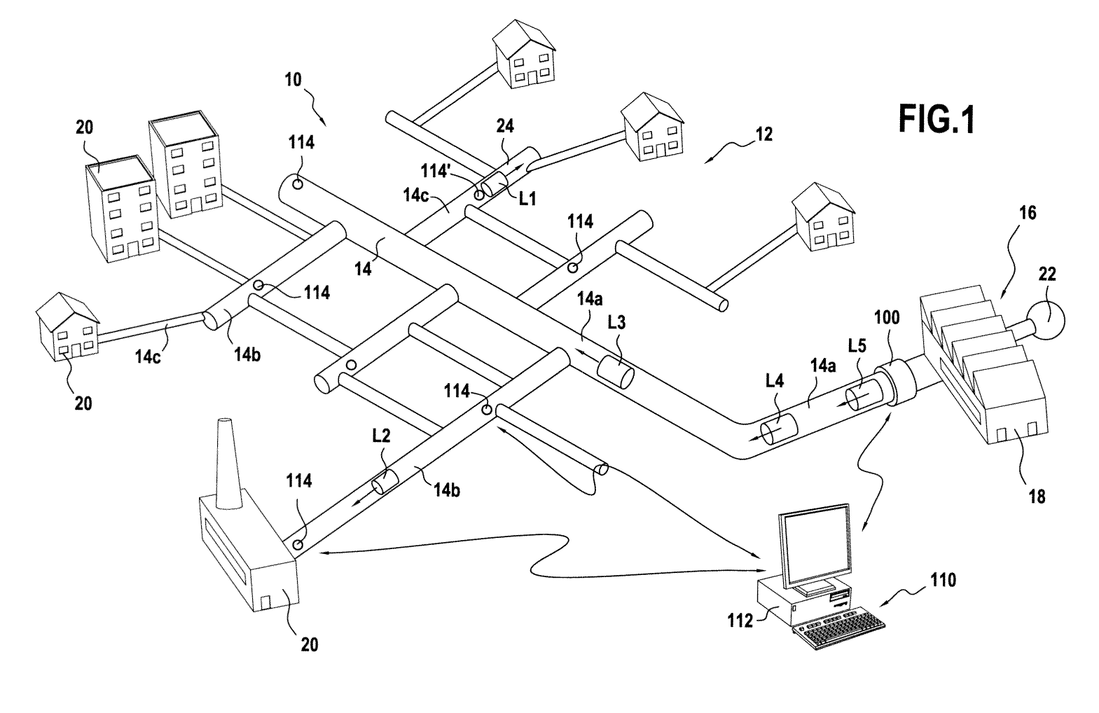

FIG. 1 shows a water distribution system 10 of the present invention.

This water distribution system comprises a known drinking-water distribution network 12 that conventionally comprises a plurality of pipes 14 forming a grid. These pipes 14 include main pipes 14 that are fed by a drinking-water source 16, in this instance a drinking-water production unit 18. Of course, without departing from the scope of the present invention, this source could instead be a reservoir.

The main pipes 14 are connected to secondary pipes 14b, 14c that supply with drinking water a plurality of consumers 20, for example individual houses, subdivisions, office and apartment buildings, nursery schools, hospitals or any other type of drinking-water consumer.

It is thus clear that drinking water flows in the pipes of the distribution network from the source 16 to the consumers 20.

Moreover, the drinking water is produced from untreated water taken from an untreated water source 22 that may for example be a ground water table, a river, or any other type of untreated water source.

In accordance with the present invention, the water distribution system further includes at least one device 100 for generating marked parcels of water. In this example, the device 100 for generating marked parcels of water is disposed on the main pipe 14a at the outlet from the drinking-water production unit 18. If the distribution network 12 is fed by other sources, such as drinking-water production units, or further includes reservoirs, other devices for generating marked parcels of water may be disposed at the outlets of those other sources.

As is explained in more detail below, the device for generating marked parcels of water generates a plurality of marked parcels of water continuously and successively. These parcels of water move in the network towards the consumers, their paths and their flow rates being in particular functions of the existing flow rates of water in the various pipes of the distribution network 12 and more generally of the structure of the grid.

In the FIG. 1 example there are shown, at a given time, five marked parcels of water L1 to L5 generated successively by the generator device 100. Thus the parcel L1, the first to be generated, has flowed in the network 12 from the time of its generation so that it is currently situated in one of the secondary pipes 14c. In contrast, the marked parcel of water L5, the last to be generated, is situated in the main pipe 14a in the vicinity of the outlet of the production unit 16.

It is thus clear that, at this given time, the residence time of the marked parcel of water L1 in the network is greater than that of the marked parcel of water L5.

Again according to the invention, each parcel of water has a marking that is specific to it, and so it is advantageously possible to track the marked parcels of water L1 to L5 in the network 12 using tracking means 110 described in detail below.

In other words, the invention makes it possible in particular to identify the positions in the network 12 of the parcels of water L1 to L5.

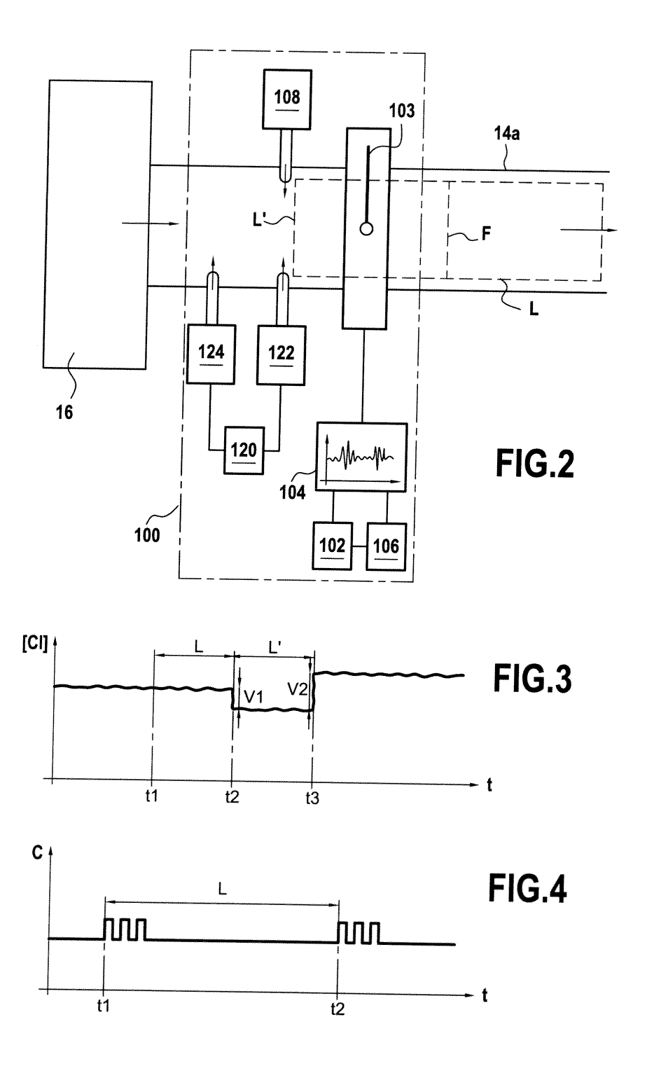

The device 100 of the invention for generating marked parcels of water is described in more detail below with reference to FIG. 2.

This device comprises means 102 for measuring at least one first physico-chemical parameter of water from the source 16, which measuring means preferably take the form of a multisensor 103 such as a probe able to measure the chlorine concentration, pH, and conductivity of the water.

In this example, the first parameter is the chlorine concentration of the water. This multisensor 103 thus measures continuously the chlorine concentration of water from the source 16.

The device 102 further includes means for defining a parcel of water based on the volume of water supplied by the source between a first time t1 and a second time t2 shown in FIG. 3. As seen on this graph, the second time t2 corresponds to a time at which the chlorine concentration, i.e. the first parameter, is subject to a variation V1 that is greater than a predetermined threshold Vo. A value of Vo in the range 5% to 15% may be chosen, for example. For the first parcel of water generated, the time t1 is chosen arbitrarily, whereas for the other parcels of water this first time preferably corresponds to the second time of the preceding parcel of water. It is thus clear that the second time t2 is not determined arbitrarily but automatically, by comparison means that compare in real time the variation of the first parameter and the predetermined threshold Vo.

In the example shown in FIG. 3, the chlorine concentration falls at the time t2. Without departing from the scope of the invention, this time t2 could equally well correspond to a significant increase in the chlorine concentration.

In the context of the invention, the marked parcel of water L corresponds to the volume of water supplied by the source 16 between the times t1 and t2.

As seen in FIG. 3, the variation V2 of the chlorine concentration at the time t3 is also greater than the predetermined threshold Vo. According to the invention, a second marked parcel of water L′ is defined between the times t2 and t3, this definition of the size of the second parcel of water also being effected automatically.

In other words, this second marked parcel of water L′ is constituted by the volume of water supplied by the source 16 between the times t2 and t3.

It is also seen that the first time of the parcel of water L′ corresponds to the second time of the preceding parcel of water L.

In a similar way, a third parcel of water L″ is then generated between the time t3 and a time t4 (not shown) that corresponds to a future time at which the variation of the chlorine concentration will be greater than the predetermined threshold.

It is thus clear that the parcels of water are defined one after the other, successively and automatically, the “frontier” between two parcels of water corresponding to a significant variation of the first parameter, here the chlorine concentration. FIG. 2 shows the frontier F between the parcels of water L and L′.

Below the expression “duration of the parcel of water” refers to the elapsed time between the first and second times that constitute the time limits of said parcel of water. Thus the duration of the parcel of water L′ at the time of its generation is equal to t2−t1, noting that this duration could evolve during the movement of the parcel of water in the network. The second time is also referred to as the “upper time limit” and the first time as the “lower time limit”. In other words, each parcel of water extends in time between its lower and upper time limits.

To mark a parcel of water, the natural evolution over time of the chlorine concentration is acquired and stored between the two times constituting the time limits of the parcel of water, after which this evolution is associated with said parcel of water.

For example, to mark the parcel of water L of FIG. 3, means 102 associate with the parcel of water L the natural evolution of the chlorine concentration between the times t1 and t2. In a similar manner, marking the parcel of water L′ consists in associating with that parcel of water the evolution of the chlorine concentration between the times t2 and t3.

To this end, the generator device 100 includes means 104 for acquiring and storing the evolution of the first parameter, in this instance the chlorine concentration.

According to an advantageous aspect of the invention, the generator device 100 further includes a database 106 in which an identifier Id is stored for each of the marked parcels L, L′, L″, for example an incremental sequence of digits, together with the evolution of the chlorine concentration between the two times constituting the time limits of said parcel of water.

Obviously, each identifier is specific to the marked parcel of water that it identifies.

For example, for the marked parcel of water L, the database contains the identifier Id(L) of the parcel of water L together with the evolution of the chlorine concentration between the times t1 and t2; for the parcel of water L′, the database contains the identifier Id(L′) of the parcel of water L′, together with the evolution of the chlorine concentration between the times t2 and t3; for the parcel of water L″, the database contains the identifier Id(L″) of the parcel of water L″ together with the evolution of the chlorine concentration between the times t3 and t4.

This evolution may take the form of a table of values, for example.

In the context of the invention, the variation of the first parameter taken into account to define the parcels of water is preferably natural but may equally be artificial. The chemical composition of the untreated water not being constant, but subject to fluctuations, it follows that the first physico-chemical parameter is also subject to natural variations.

Given that the natural variations are more or less pronounced, it may be advantageous in some circumstances, if necessary, to effect artificial marking by further carrying out an artificial marking step in which at least one marking product, in this instance chlorine, is injected into water from the source 16 to modify the value of the chlorine concentration.

It is thus clear that in this situation some of the times defining the marked parcels of water are going to be “provoked” because injecting the marking product, i.e. the chlorine, is going to provoke a variation in the chlorine concentration greater than the predetermined threshold.

Such injection may be carried out periodically, for example, or when a time greater than a preset limiting time has elapsed from the time constituting the upper time limit of the preceding parcel of water. This enables a maximum size for the parcels of water to be decided on.

This artificial marking step is carried out by marker means 108, in this instance a reservoir of a chlorinated disinfectant product.

The marker additive may be injected on a one-off and unique basis or follow a marking injection rule, for example a “pulse” function as shown diagrammatically in

FIG. 4. The duration of the signal conforming to the injection rule is preferably short compared to the duration of the parcel of water.

In a variant of the method of generating marked parcels of water, a second physico-chemical parameter is also measured, for example the pH of water from the source 16.

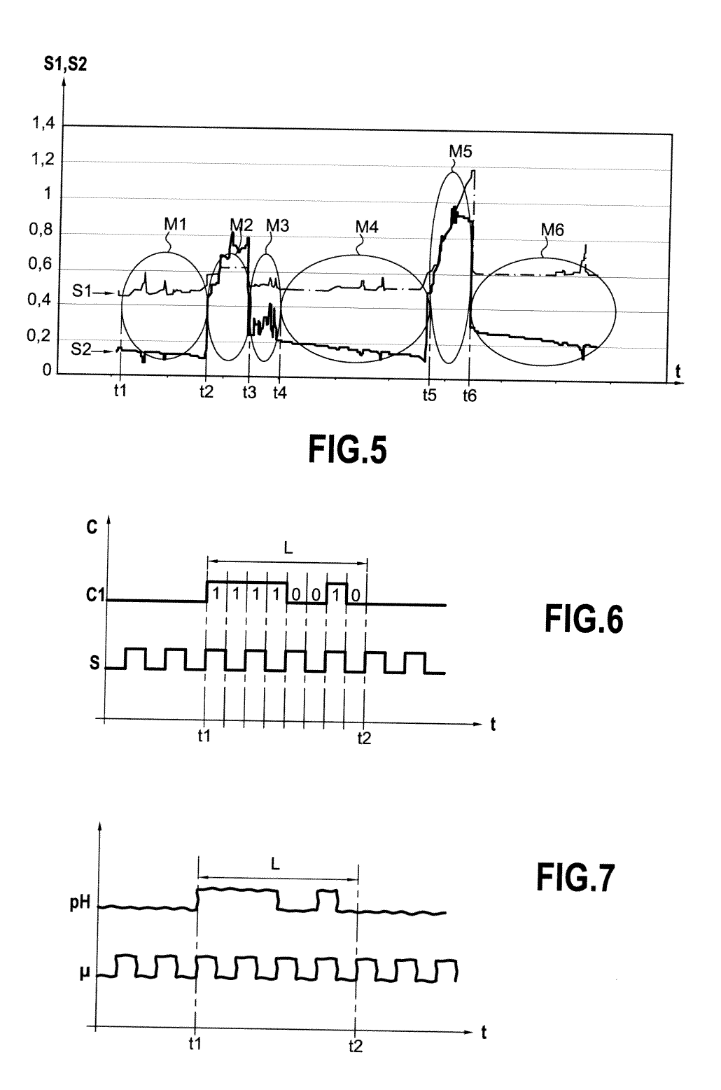

FIG. 5 shows diagrammatically the evolution over time of the chlorine concentration (S1) and the pH (S2) of water from the source 16.

In this variant, the second time, i.e. the time constituting the upper time limit of each parcel of water, corresponds to the time at which the variation of the chlorine concentration, preferably in terms of its absolute value, exceeds a predetermined first threshold and the variation of the pH of the water, preferably in terms of its absolute value, exceeds a predetermined second threshold. The predetermined first and second thresholds may be a percentage in the range 5% to 15%, for example.

Referring to FIG. 5, it is seen that the time t2 corresponds, for example, to a time at which the chlorine concentration and the pH increase significantly so that their absolute-value variations are greater than the predetermined first and second thresholds at this time.

The same applies to the time t5.

Moreover, it is seen that the times t3, t4, and t6 are times at which the chlorine concentration and the pH fall significantly so that their absolute value variations are greater than the predetermined first and second thresholds at these times.

It follows that the times t1 to t6 make it possible to define the parcels of water M1 to M5 shown in FIG. 5: the parcel of water M1 is defined between the times t1 and t2, the parcel of water M2 is defined between the times t2 and t3, the parcel of water M3 is defined between the times t3 and t4, the parcel of water M4 is defined between the times t4 and t5, the parcel of water M5 is defined between the times t5 and t6, and the parcel of water M6 is defined between the time t6 and a future time that is not shown here.

According to the invention, each parcel of water M1 to M5 is marked by associating with said parcel of water the evolutions of the chlorine concentration and the pH of the water between these first and second times. For example, the parcel of water M3 is marked by associating with that parcel of water the evolution of the chlorine concentration and the pH between the times t3 and t4.

These evolutions are clearly seen in the FIG. 3 example. They are moreover stored in the above-mentioned database 106 that, in this variant, contains the identifiers of the marked parcels of water and the evolutions of the chlorine concentration and the pH between the lower and upper time limits for each marked parcel of water.

According to another advantageous aspect of the invention, information is coded in one or more of the marked parcels of water. In other words, information is written explicitly into these marked parcels of water.

This coded information may subsequently be read as explained below.

To effect this coding, a modulation step is carried out in accordance with the invention, which modulation step consists in injecting into water from the source 16 at least one first modulation additive, in this instance an acid species. The injection of the first modulation additive has the effect of modifying one of the physico-chemical parameters referred to as “the information-carrying parameter”, in this instance the pH. It is the variation over time of the information-carrying parameter that makes it possible to code and decode information in the marked parcel of water. In this example, the acid species is injected in accordance with a modulation injection rule between the first and second times of each of the marked parcels of water. Obviously, it is possible to use as the information-carrying parameter a parameter that is identical to the marker parameter. In this situation the modulation injection rule must be different from the marking injection rule so as to avoid confusion between the signals.

In this example, the modulation injection rule shown in FIG. 6 is chosen so that the rule corresponds to the translation into binary of the information to be coded in the marked parcel of water L. To be more precise, in this particular non-limiting example, the word coded in binary on eight bits is: “11110010”. To this end, a quantity of acid species is injected for four time units, after which injection ceases for two time units, after which a quantity of acid species is injected for one time unit, after which injection ceases for one time unit. The time unit is of the order of a few seconds, for example.

The consequence of this injection is seen in the evolution of the information-carrying parameter; the curve of the pH of the water between the times t1 and t2 advantageously has a shape very similar to that of the modulation injection rule, as seen clearly in FIG. 7.

Obviously, without departing from the scope of the invention, a different number of bits could be chosen to code the information. It is equally possible to choose any other form of coding, for example using amplitude modulation. In this example, the word “11110010” corresponds to the identifier of the production unit 16, i.e. the source from which the marked parcel of water in question comes. Alternatively, the date or time at which the marked parcel of water is defined could very well be coded by this means.

According to the invention, the coding may optionally be encrypted, as a function of the required use, and using known encryption algorithms.

What is more, to make reading the information more reliable, the same information may be coded using a plurality of parameters carrying the information. To this end, a plurality of modulation additives could be injected in accordance with the same modulation rule.

A second modulation product, in this instance nanofiltered water, is preferably, but not necessarily, also injected into water from the source during the above-mentioned modulation step, at least between the first and second times.

This nanofiltered water is injected in accordance with a clock-type injection rule as shown in FIG. 6: in this instance a periodic pulse function constituted by a series of “0s” and “1s”. To this end a quantity of nanofiltered water is injected for one time unit, after which injection ceases for another time unit, after which a quantity of nanofiltered water is injected for one time unit, and so on. The time unit is preferably the same as that used for the modulation injection rule.

The injection of nanofiltered water modifies the conductivity p of the water from the source 16, so that there is obtained between the times t1 and t2 a conductivity curve of the pulse type similar to that of an injection rule of the clock type.

FIG. 7 shows the curves of pH and of conductivity p for the water between the times t1 and t2 and as supplied by the multisensor 103. Note that the overall waveforms of the modulation and clock-type injection rules can be seen.

Without departing from the scope of the invention, the clock signal may also be coded by injecting a plurality of second modulation additives using the same clock-type injection rule.

By means of the invention, it is therefore possible to code the signal “11110010” in the marked parcel of water L defined between the times t1 and t2 as well as a clock-type signal S.

The modulation step is carried out by modulation means 120 adapted to code information in the marked parcels of water, to control a device 122 for injecting the first modulation product, i.e. the acid species, and to control a device 124 for injecting the second modulation product, i.e. the nanofiltered water.

Obviously, the quantities of marker and modulation additives injected are chosen so that the concentrations of marking and modulation additives in the water network do not exceed applicable standards.

Referring again to FIG. 1, there follows a description of how the marked parcels of water L1 to L5 may be tracked in the network and how it is possible to read the coded information that they may contain.

In this example, each of the marked parcels of water L1 to L5 contains information relating to its source 16.

As indicated above, the tracking means 110 enable the marked parcels of water to be tracked in the network.

To this end, these tracking means include calculation means 112, in this instance a computer, and a plurality of sensors 114 disposed on the main and secondary pipes 14a, 14b, 14c of the distribution network.

The sensors of the network are also multisensors, i.e. they are adapted to measure the evolution of different physico-chemical parameters of the water, and in particular the above-mentioned first and second parameters, the marker parameter or parameters, the information-carrying parameter or parameters, and the clock-signal parameter or parameters.

In this example, the sensors 114 are adapted to measure the chlorine concentration, the pH, and the conductivity of the water.

The calculation means 112 recover the data sent by the sensors 114, for example by coded or uncoded wireless transmission means. From this data, the calculation means 112 identify the parcels of water L1 and L5 and determine their positions in the network 12.

To this end, the calculation means 114 use a mathematical algorithm that compares, preferably in real time, the evolutions of the various physico-chemical parameters of the water as measured by the sensors 114 with their evolutions as stored in the database 106.

If the calculation means 112 determine that an evolution as measured by one of the sensors 114 is strongly correlated with an evolution as stored in the database 106, then the operative is alerted that there is a high probability that the marked parcel of water whose identifier is associated with that stored evolution is at the location of the sensor 114.

This advantageously locates this marked parcel of water.

If the database contains more than one evolution for the same marked parcel of water identifier, the probability that there is a marked parcel of water at the location of the sensor 114 is higher if the calculation means 112 determine that the evolution of the first and second physico-chemical parameters as measured by the sensor 114 are both strongly correlated with the stored evolution associated with that marked parcel of water.

A first detection time ta and a second detection time tb are two times constituting the lower and upper time limits of the marked parcel of water at the time of its detection by the sensor 114. The duration of the parcel of water at the time of its detection by a sensor of the network is generally different from its duration at the time of its definition because the parcel of water is naturally deformed as it propagates in the network.

In this example, the calculation means determine that the evolution of the chlorine concentration detected between the times ta and tb by the sensor 114′ corresponds to the evolution associated with the parcel of water L1 as shown in FIG. 9.

Once one of the marked parcels of water L1 has been located in the network 12, the calculation means 112 are also able to read the information coded in that parcel of water using appropriate reader means.

These reader means use the evolution of the parameters or parameters carrying the coded information and, where appropriate, the evolution of the parameter or parameters carrying the clock signal as measured, preferably between the first and second detection times, by the sensor that located the marked parcel of water.

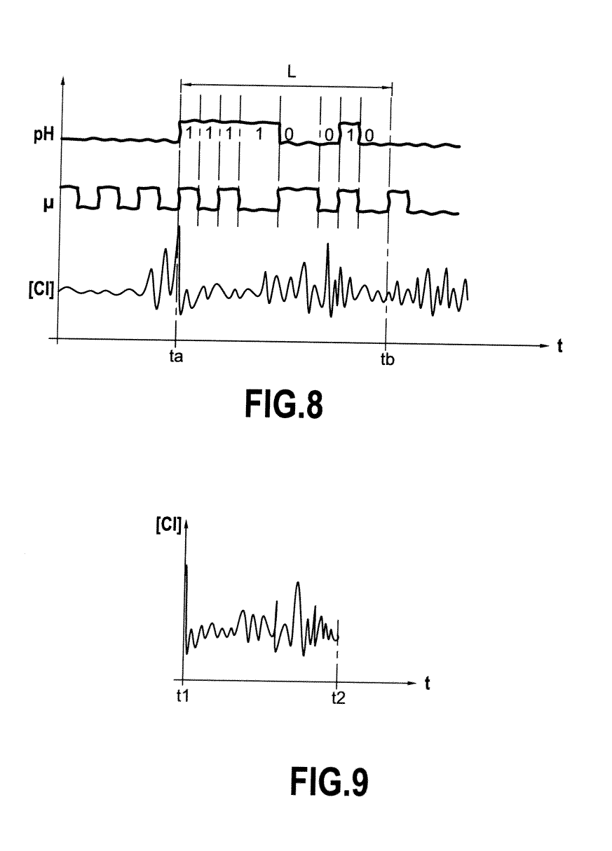

For example, FIG. 8 shows the evolution of the information-carrying parameter, in this instance the pH, and the evolution of the clock-signal parameter, in this instance the conductivity p, as measured by the sensor 114′, by means of which the parcel of water L1 has been located.

Obviously, the signal coding the information is highly distorted and decoding it may prove difficult. The clock-type signal advantageously enables the information to be decoded anyway.

The rising and falling edges of the clock signal S remain identifiable even though they are distorted as well.

These edges advantageously serve as graduations for deciphering the word coded in the information-carrying parameter, as shown in FIG. 8.

Thus the calculation means make it possible to determine that the marked parcel of water contains the binary word “11110010”.

The calculation means 112 are also adapted to translate this binary word in order to indicate to the operative its real meaning, here the identifier of the source of the marked parcel of water.

Obviously, without departing from the scope of the invention, other information may also be coded in the same parcel of water.

If the distribution network is fed by a plurality of sources (for example two drinking-water production units or a drinking-water production unit and a reservoir), marking parcels from each source by modulating different physico-chemical parameters advantageously makes it possible to identify the mixing of parcels from different sources in the distribution network.

According to another advantageous aspect of the invention, the water distribution system 10 further includes a digital model of the hydraulic and kinetic behavior of the distribution network. At present there are several ways of calibrating this digital model so that the behavior simulated by the model corresponds to the real behavior.

The invention proposes to use tracking of the marked parcels of water to calibrate the digital model. To this end, marked parcels of water are generated having a special marking that is intended for calibrating the model. Afterwards, the digital model is recalibrated using positions simulated by the model and real positions as determined in accordance with the present invention.

1. A method of generating a series of successive marked parcels of water in a water distribution network fed by at least one water source supplying water continuously, the method comprising:
a step of measuring at least one first physico-chemical parameter of water from the source;
a step of comparing the variation of the measured first parameter and a predetermined threshold;
a step of defining parcels of water during which each parcel of water is constituted by the volume of water supplied by the source between a first time and a second time later than the first time, the second time being determined automatically so as to correspond to a time at which said at least one measured first parameter is subject to a variation greater than the predetermined threshold;
a step of acquiring and storing a natural evolution of the measured first parameter between said first and second times; and
a step of natural marking of said parcel of water that consists in associating said natural evolution of said first parameter with said parcel of water.

2. A generation method according to claim 1, wherein said at least one first parameter is selected from the chlorine concentration, pH, conductivity, turbidity, mineral species concentration, and natural isotopes.

3. A generation method according to claim 1, characterized in that it further includes an artificial marking step in which there is injected into water from the source at least one marker additive to modify significantly the value of said at least one first parameter, this injection being effected at least at the first time and/or at the second time.

4. A generation method according to claim 3, wherein the artificial marking step consists in carrying out a plurality of successive injections of marker additive in accordance with a marking injection rule.

5. A generation method according to claim 3, wherein the marker additive is selected from a chlorinated disinfectant, a reagent adapted to modify the pH or the mineral content of the water, a substance inhibiting the precipitation of CaCO3 and corrosion, nanofiltered water, a mineral species, and natural isotopes.

6. A generation method according to claim 1, wherein the measuring step further includes measuring a second physico-chemical parameter of water from the source, the second time corresponds to a time at which the first parameter is subject to a variation greater than a predetermined first threshold and the second parameter is subject to a variation greater than a predetermined second threshold, there is further effected a step of acquiring and storing an evolution of the measured second parameter between the first and second times, and the marking step consists in associating with said parcel of water the evolution of the first and measured second parameters.

7. A generation method according to claim 1, characterized in that it further includes a modulation step consisting in injecting into water from the source, between the first and second times and in accordance with a modulation injection rule, at least one first modulation additive adapted to modify the value of one of said physico-chemical parameters of the water, the information-carrying parameter, so as to code information in the parcel of water.

8. A generation method according to claim 7, wherein the coded information relates in particular to the identification of the water source and/or the date and time of definition of the marked parcel of water.

9. A generation method according to claim 7, wherein, during the modulation step, a second modulation additive is injected into water from the source between the first and second times and in accordance with an injection rule of the clock type, said second modulation additive being adapted to modify the value of another of said physico-chemical parameters of the water, the clock-signal parameter, to code a clock signal in the marked parcel of water.

10. A generation method according to claim 9, wherein the first modulation additive is an acid species, the information-carrying parameter is the pH, the second modulation additive is nanofiltered water, and the clock-signal parameter is the conductivity.

11. A marked parcel of water obtained by using the method according to any one of claims 1 to 10.

12. A device for generating a series of successive marked parcels of water in a water distribution network fed by at least one water source supplying water continuously, the device being characterized in that it comprises:
means for measuring at least one first physico-chemical parameter of water from the source;
means for comparing the variation of the measured first parameter and a predetermined threshold;
means for defining parcels of water, each parcel of water being constituted by the volume of water supplied by the source between a first time and a second time later than the first time, the second time being determined automatically so as to correspond to a time at which the first parameter is subject to a variation greater than the predetermined threshold;
means for acquiring and storing a natural evolution of the measured first parameter between said first and second times; and
means for natural marking of said parcel of water by associating said natural evolution with said parcel of water.

13. A generator device according to claim 12, characterized in that it further includes a database in which are stored for each marked parcel of water both an identifier of said marked parcel of water and the evolution of the first parameter.

14. A generator device according to claim 12, characterized in that it further includes artificial marker means for injecting into water from the source at least one marker additive for significantly modifying the value of the first parameter, this injection being carried out in accordance with a marking injection rule at least at the first time and/or at the second time.

15. A generator device according to any one of, characterized in that it further includes modulation means for coding information in the parcel of water, said means being adapted to inject into water from the source, between the first time and the second time and in accordance with a modulation injection rule, at least one first modulation additive adapted to modify the value of a physico-chemical parameter of the water, the information-carrying parameter.

16. A water distribution system comprising at least one water source, a water distribution network fed by said source and provided with a plurality of pipes, at least one device according to claim 12 for generating marked parcels of water disposed at the outlet of the water source to generate continuously a plurality of marked parcels of water, and tracking means for tracking the marked parcels of water in the network.

17. A water distribution system according to claim 16, characterized in that the tracking means comprise:
a plurality of sensors disposed on the pipes of the network, said sensors being adapted to measure the variation over time of at least the first parameter;
calculation means for identifying the batches of water and determining their position in the network from the measurements provided by the sensors and all of the stored evolutions.

18. A water distribution system according to claim 17, characterized in that it includes at least first and second water sources, the first water source being associated with a first device for generating marked parcels of water generating a series of first marked parcels of water, while the second water source is associated with a second device for generating marked parcels of water generating a series of second marked parcels of water, and the calculation means are also adapted to determine the source of a portion of water resulting from mixing of the first and second parcels of water.

19. A water distribution system according to claim 16 in combination with claim 15, characterized in that it further includes reader means for reading the information coded in each parcel of water.

20. A water distribution system according to claim 16, characterized in that it further includes a digital model of the hydraulic and kinetic behavior of the distribution network and said model is updated from data supplied by the tracking means.
